(19) United States
(12) Patent Application Publication
(10) Pub. No.: US 2008/0295969 A1
(43) Pub. Date: Dec. 4, 2008

(54) Foil transfer apparatus

(75) Inventor: Shin Ohsawa, Tsukuba-shi (JP)

Correspondence Address: BIRCH STEWART KOLASCH & BIRCH, PO BOX 747, FALLS CHURCH, VA, 22040-0747, US

(73) Assignee: KOMORI CORPORATION

(21) Appl. No.: 12/153,964

(22) Filed: May 28, 2008

(30) Foreign Application Priority Data
May 31, 2007 (JP) 2007-144595
Mar. 19, 2008 (JP) 2008-070571

(51) Int. Cl. B29C 65/80

(52) U.S. Cl. 156/540

(57) ABSTRACT

A foil transfer apparatus includes: a transport cylinder supporting a paper sheet on its outer circumferential surface; and a press roller opposing the transport cylinder and having a notch portion formed in its outer circumferential surface, wherein the paper sheet and a web-like transfer foil made by attaching foil on a base film travel through the nip between the transport cylinder and the press roller, thereby transferring the foil of the transfer foil onto the paper sheet. The foil transfer apparatus also includes a discharging guide disposed near a nip portion between the transport cylinder and the press roller, on the downstream side of the traveling direction of the transfer foil, at the press-roller side, in order to guide the transfer foil so that the transfer foil can travel closer to the press-roller side than a tangent line passing through the nip portion.

### BACKGROUND OF THE INVENTION

1. Field of the Invention

The present invention relates to a foil transfer apparatus that transfers foil of transfer foil onto a transfer object.

2. Description of the Related Art

FIG. 11 shows a schematic configuration of an example of a conventional foil transfer apparatus that transfers foil of transfer foil onto a web or the like.

FIG. 11 shows an anvil roller 11 and a press roller 12. A web 3 travels on the anvil roller 11. Plural protruding portions 12a that are brought into contact with an anvil roller 11 are disposed on the press roller 12 at predetermined intervals in the circumferential direction of the press roller 12. Transfer foil 1 that is wound into a roll shape is rotatably set on a feeder shaft 13. The transfer foil 1 includes a base film that is made of a resin or the like. A parting-agent layer or the like is formed on the base film, and, in addition, a layer of foil made of a metal or the like is formed on the parting-agent layer or the like. The roll-shaped transfer foil 1 that is held on the feeder shaft 13 travels through the nip between the anvil roller 11 and the press roller 12, and is then rewound on a winding shaft 14.

A pair of feeder rollers 15 that are capable of driven to rotate are disposed near the feeder shaft 13, and pinch the transfer foil 1 unwound from the feeder shaft 13. Guide rollers 16 and 17 are disposed respectively at the feeder-shaft 13 side and the winding shaft 14 side, each located between the anvil roller 11 and the press roller 12. The guide rollers 16 and 17 guide the transfer foil 1 positioned between the anvil roller 11 and the press roller 12 so that the transfer foil 1 passes in a tangential direction relative to the anvil roller 11.

Guide rollers 18 to 20 that guide the transfer foil 1 are disposed between the feeder rollers 15 and the guide roller 16. Meanwhile, guide rollers 21 to 23 that guide the transfer foil 1 are disposed between the guide roller 17 and the winding shaft 14.

An adjustment mechanism 24 is attached to the guide rollers 19 and 22 so as to adjust a traveling path of the transfer foil 1 on the guide-roller 18 to 20 side and on the guide-roller 21 to 23 side, respectively. The adjustment mechanism 24 is capable of changing the position of the guide rollers 19 and 22 synchronously. Specifically, while the traveling path of transfer foil 1 is made longer on the guide-roller 18 to 20 side, the traveling path of transfer foil 1 is made shorter on the guide-roller 21 to 23 side. Alternatively, while the traveling path of transfer foil 1 is made shorter on the guide-roller 18 to 20 side, the traveling path of transfer foil 1 is made longer on the guide-roller 21 to 23 side.

FIG. 11 also shows a driving motor 15a for the feeder rollers 15 and a driving motor 24a for the adjustment mechanism 24.

Next, descriptions will be given as to the operation of the conventional foil transfer apparatus.

The anvil roller 11 is driven to rotate so that the web 3 can travel. Meanwhile, the driving motor 15a is activated to make the feeder rollers 15 be driven to rotate. Simultaneously, the press roller 12 and the winding shaft 14 are driven to rotate so as to make the transfer foil 1 be fed and traveled from the feeder shaft 13. When the protruding portions 12a of the press roller 12 oppose the outer circumferential surface of the anvil roller 11, the transfer foil 1 is pressed onto the web 3 by the protruding portions 12a of the press roller 12. Thus, the foil of a shape corresponding to the design formed on each of the protruding portions 12a of the press roller 12 is transferred onto the web 3. After that the transfer foil 1 is wound and collected by the winding shaft 14. In this way, the foil with shapes corresponding to the design is continuously attached onto the web 3.

At this time, assume that the transfer foil 1 and the web 3 travel always at the same speed. In this case, a portion of the foil opposing a portion of the web 3 onto which no foil is transferred is wasted, i.e., there is generated a large amount of the foil that is not transferred onto the web 3 so as to be wound onto the collection shaft 14. To address this problem, after one of the protruding portions 12a of the press roller 12 opposes the outer circumferential surface of the anvil roller 11 to transfer the foil of the transfer foil 1 onto the web 3, the driving motor 24a for the adjustment mechanism 24 is actuated so that the adjustment mechanism 24 moves the guide rollers 19 and 22. The guide rollers 19 and 22 thus moved change the traveling path of transfer foil 1 on the guide-roller 21 to 23 side as well as on the guide-roller 18 to 20 side, before the other one of the protruding portions 12a of the press roller 12 comes to oppose the outer circumferential surface of the anvil roller 11.

In this way, when the second one of the protruding portion 12a of the press roller 12 comes to oppose the outer circumferential surface of the anvil roller 11, a portion of the transfer foil 1 located near the position of a transfer part that has been first transferred onto the web 3 comes to be positioned between the protruding portion 12a of the press roller 12 and the outer circumferential surface of the anvil roller 11. The distance between the transfer part on the transfer foil 1 having been first transferred onto the web 3 and the transfer part to be secondly transferred onto the web 3 can be made very short. Consequently, a significant reduction in the foil of the transfer foil 1 that is to be wasted is achieved (foil-saving mechanism: for more detailed descriptions of the operation, see U.S. Pat. No. 6,334,248, and U.S. Pat. No. 6,491,780, for example).

In addition, the guide rollers 16 and 17 are disposed so that the transfer foil 1 positioned between the anvil roller 11 and the press roller 12 can pass tangentially to the anvil roller 11. Thus, an unnecessary friction between the transfer foil 1 and the web 3 is prevented.

Incidentally, in the conventional foil transfer apparatus such as one that has been described above, when the tensile force of the transfer foil 1 between the guide rollers 16 and 17 is too large, creases occur in the transfer foil 1. As a result, a problem occurs in which the foil on the transfer foil 1 has cracks, creases, and the like. For this reason, it is preferable that the tensile force of the transfer foil 1 be set low. However, the tensile force of the transfer foil 1 between the guide rollers 16 and 17 is small, a problem such as one shown in FIG. 12 occurs under some transfer conditions. To be more specific, it is not easy to separate the base film of the transfer foil 1 from the web 3, even after the transfer foil 1 has passed through the nip portion between the rollers 11 and 12. This results in the following phenomenon. The base film of the transfer foil 1 sticks to the web 3 in a section from the position where the press roller 12 and the anvil roller 11 oppose each other to a position on the further downstream-side in the rotational direction of the anvil roller 11. As a consequence, disturbances tend to occur in the tensile force of the transfer foil in portions near the nip between the press roller 12 and the anvil roller 11. As a result, cracks and creases occur in the foil that has been transferred onto the web 3 as well as the foil on the transfer foil 1. This phenomenon particularly occurs in an apparatus in which a transfer object, to which foil is transferred, opposes a press cylinder and is transported so as to be wound around the circumferential surface of a supporting cylinder that supports the transfer object.

For this reason, it is extremely difficult to adjust the tensile force of the transfer foil 1 in the conventional foil transfer apparatus such as one described above.

A possible measure to address the above-mentioned difficulty is described in JP-A-2006-224667, for example. In the disclosure, the transfer foil is made to travel so as to be wound around the press roller for the purpose of preventing the disturbances in the tensile force of the transfer foil and of preventing the occurrence of cracks and creases in the foil that has been transferred onto the web as well as the foil on the transfer foil. As a result of this measure, however, foil saving is difficult to be securely carried out.

### SUMMARY OF THE INVENTION

In view of the circumstances described above, the present invention aims to provide a foil transfer apparatus that is capable of stabilizing the tensile force of the transfer foil with ease and capable of carrying out foil saving securely.

A foil transfer apparatus according to the present invention is provided to address the above-described problems. The foil transfer apparatus comprising: a supporting cylinder that is rotatably supported and supports a transfer object on the outer circumferential surface of the supporting cylinder; and a press cylinder that is rotatably supported and disposed so as to oppose the supporting cylinder. The foil transfer apparatus that causes the transfer object and a web-like transfer foil made by attaching foil on a base film to travel through the nip between the supporting cylinder and the press cylinder, and thereby transferring the foil of the transfer foil on the transfer object. In addition, the foil transfer apparatus, further comprising: a downstream-side guide member which is disposed at a position near the nip portion between the supporting cylinder and the press cylinder, on the downstream-side of the traveling direction of the transfer foil on the press cylinder side, and which guides the transfer foil, so that the transfer foil travels closer to the press cylinder side than a tangent line passing through the nip portion.

Another foil transfer apparatus according to the present invention provides the above-described foil transfer apparatus in which the downstream-side guide member is disposed at a position near the press cylinder.

Another foil transfer apparatus according to the present invention provides the above-described foil transfer apparatus in which the downstream-side guide member has an arc-shaped guide face that guides the transfer foil.

Another foil transfer apparatus according to the present invention provides the above-described foil transfer apparatus in which the downstream-side guide member has: a guide face that guides the transfer foil; and an ejection hole that is provided in the guide face to eject air supplied from air supply means.

Another foil transfer apparatus according to the present invention provides the above-described foil transfer apparatus in which the downstream-side guide member has a guide face that guides the transfer foil with an end portion located on the upstream side in the traveling direction of the transfer foil, the end portion being curved and thereby a gap being created between the end portion and the transfer foil.

Another foil transfer apparatus according to the present invention provides the above-described foil transfer apparatus in which the downstream-side guide member has a face which opposes the press cylinder and which has an arc shape along the outer circumferential surface of the press cylinder.

Another foil transfer apparatus according to the present invention provides the above-described foil transfer apparatus in which the downstream-side guide member is formed to have a thickness in a radial direction of the press cylinder on the upstream side in the traveling direction of the transfer foil, the thickness becoming thinner as the guide member approaches the upstream side in the traveling direction.

Another foil transfer apparatus according to the present invention provides the above-described foil transfer apparatus in which the press cylinder has a notch portion on the outer circumferential surface thereof, and the downstream-side guide member guides the transfer foil so that when the notch portion of the press cylinder opposes the supporting cylinder, the transfer foil travels through the area of the notch portion of the press cylinder.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a schematic configuration diagram of a principal portion of a foil transfer apparatus according to an embodiment of the present invention;

FIG. 2 shows an enlarged diagram of a principal portion extracted from FIG. 1;

FIG. 3 shows an enlarged diagram of a principal portion extracted from FIG. 2;

FIG. 4 shows an explanatory diagram for an operation of the principal portion of the foil transfer apparatus shown in FIG. 1;

FIG. 5 shows an explanatory diagram for an operation that follows the operation described in FIG. 4;

FIG. 6 shows an explanatory diagram for an operation that follows the operation described in FIG. 5;

FIG. 7 shows an explanatory diagram for an operation that follows the operation described in FIG. 6;

FIG. 8 shows a schematic configuration diagram of a principal portion of a foil transfer apparatus according to another embodiment of the present invention;

FIG. 9 shows an explanatory diagram for an operation of the principal portion of the foil transfer apparatus shown in FIG. 8;

FIG. 10 shows an explanatory diagram for foil saving carried out in a foil transfer apparatus according to still another embodiment of the present invention;

FIG. 11 shows a schematic configuration diagram of a principal portion of an example of conventional foil transfer apparatuses; and

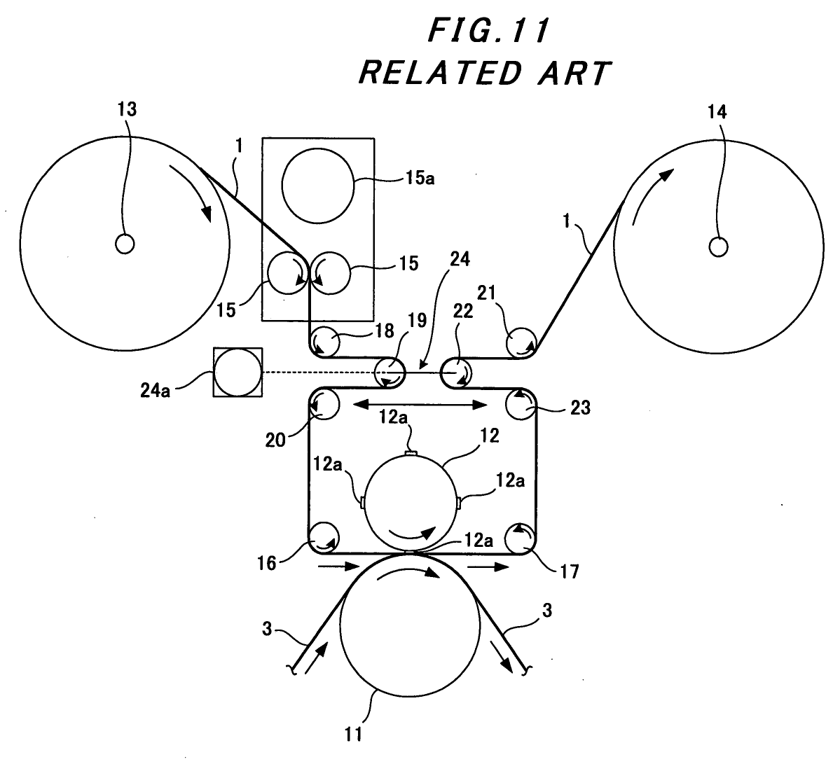

FIG. 12 shows an explanatory diagram for a problem that occurs in the example of conventional foil transfer apparatuses.

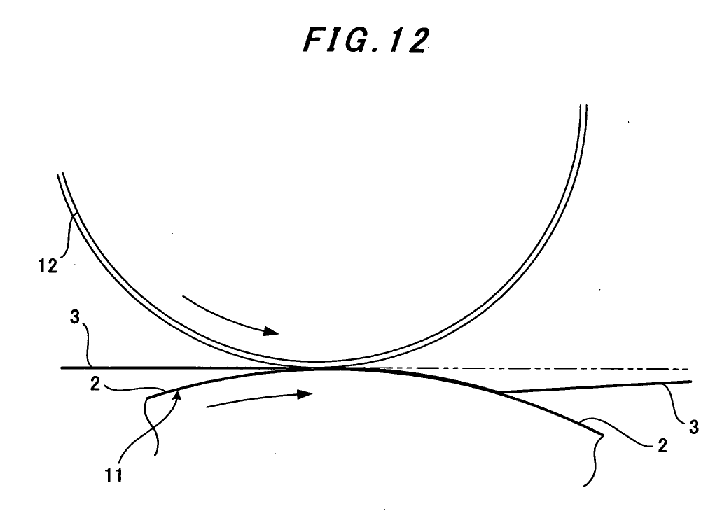

### DETAILED DESCRIPTION OF THE INVENTION

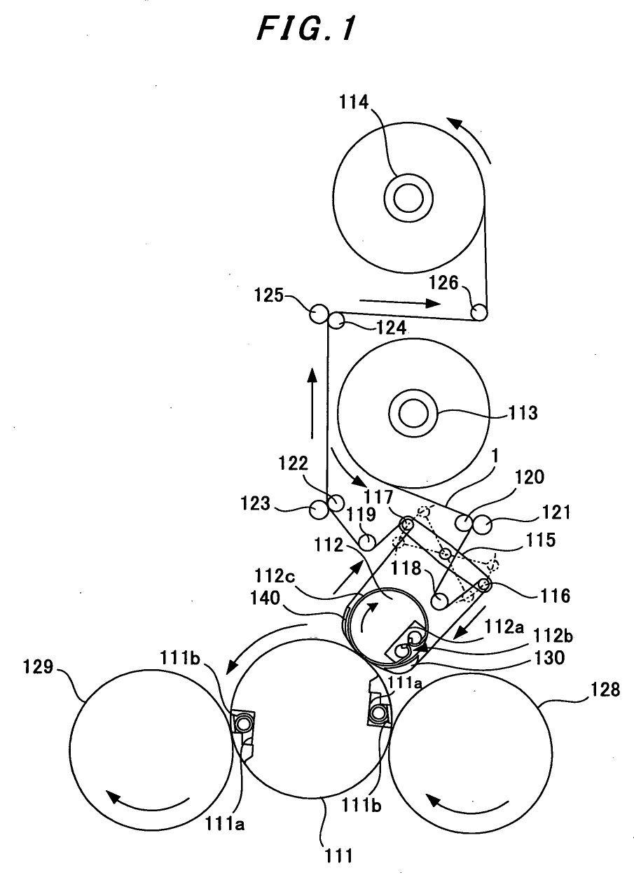

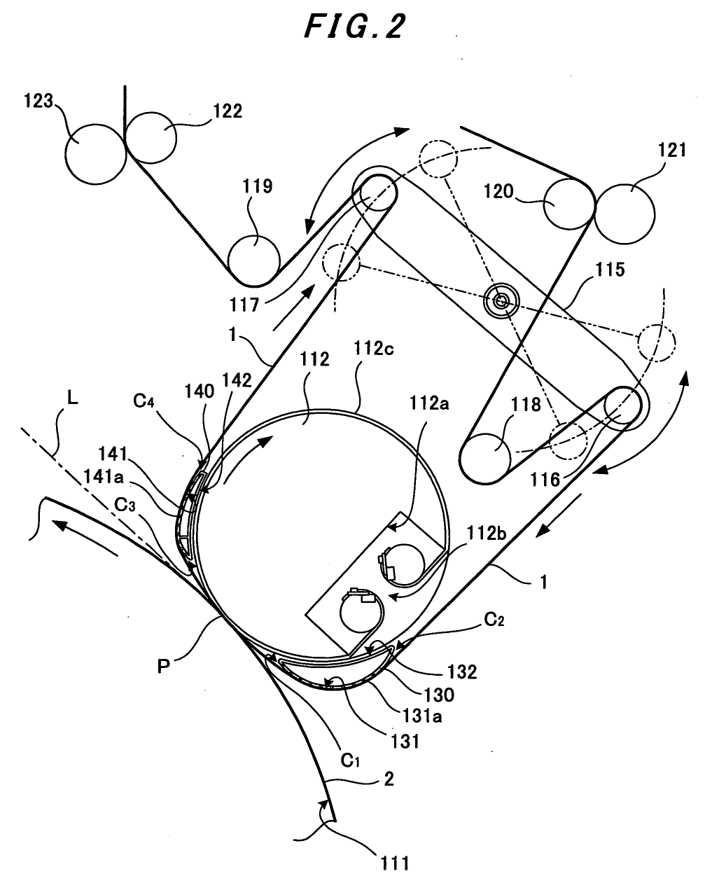

An embodiment in which the present invention is applied to a cold-foil-transfer type foil transfer apparatus will be described with reference to FIGS. 1 to 7.

FIGS. 1 to 3 show that a transfer cylinder 128 opposees a transport cylinder (an impression cylinder) 111. The transport cylinder 111 is a sheet-transport cylinder for supporting a sheet. To be more specific, the transport cylinder 111 supports a paper sheet 2, which is an example of the transfer-object sheet, on its outer circumferential surface. To this end, notch portions 111a are formed in the outer circumferential surface of the transport cylinder 111. A gripper device 111b is installed in each of the notch portions 111a, and holds the front-end side of the paper sheet 2. The transfer cylinder 128 transfers the paper sheet 2 from a feeder apparatus to the transport cylinder 111. Here, onto the paper sheet 2, adhesive agent that corresponds to a design has been transferred with an adhesive-agent transfer apparatus.

A press roller 112, which is a press cylinder, opposes the transport cylinder 111 at a point on the more downstream side of the transport cylinder 111 in the transporting direction of the paper sheet 2 than the transfer roller 128. A pressing surface member 112c, which is sheet-shaped and made of resin, rubber, or the like, is supported on the outer circumferential surface of the press roller 112. To this end, a notch portion 112a is formed in the outer circumferential surface of the press roller 112 while a tightening reel apparatus 112b is installed in the notch portion 112a so as to hold end portions of the pressing surface member 112c. A transfer roller 129, which transfers the paper sheet 2 from the transport cylinder 111 to the side of a discharging apparatus, opposes the transport cylinder 111 at a point on the more downstream side than the press roller 112 in the transporting direction of the paper sheet 2.

A transfer foil 1 that is wound into a roll shape is rotatably supported on a feeder shaft 113. The transfer foil 1 includes a base film that is made of a resin or the like. A parting-agent layer or the like is formed on the base film, and, in addition, a layer of foil made of a metal or the like is formed on the parting-agent layer or the like. A winding shaft 114 is disposed near the feeder shaft 113 to wind the transfer foil 1. The roll-shaped transfer foil 1 held on the feeder shaft 113 passes through the nip between the transport cylinder 111 and the press roller 112, and then is wound on the winding shaft 114.

Reference numeral P represents the nip portion between the transport cylinder 111 and the press roller 112. An upstream-side guide member is disposed near the point P, at the press-roller 112 side of the transfer foil 1, and on the upstream side of the traveling direction of the transfer foil 1, and is shown as a feeding guide 130 in the drawings. The transfer foil 1 coming from the feeder shaft 113 and thus guided by the feeding guide 130 travels through the nip between the transport cylinder 111 and the press roller 112.

The feeding guide 130 has a hollow structure and is connected to unillustrated air-supply means, specifically, an air pump. The feeding guide 130 has an arc-shaped guide face 131 which is positioned on the outer side in a radial direction of the press roller 112 and which guides the traveling direction of the transfer foil 1. A large number of ejection holes 131a are formed in the guide face 131 to eject air.

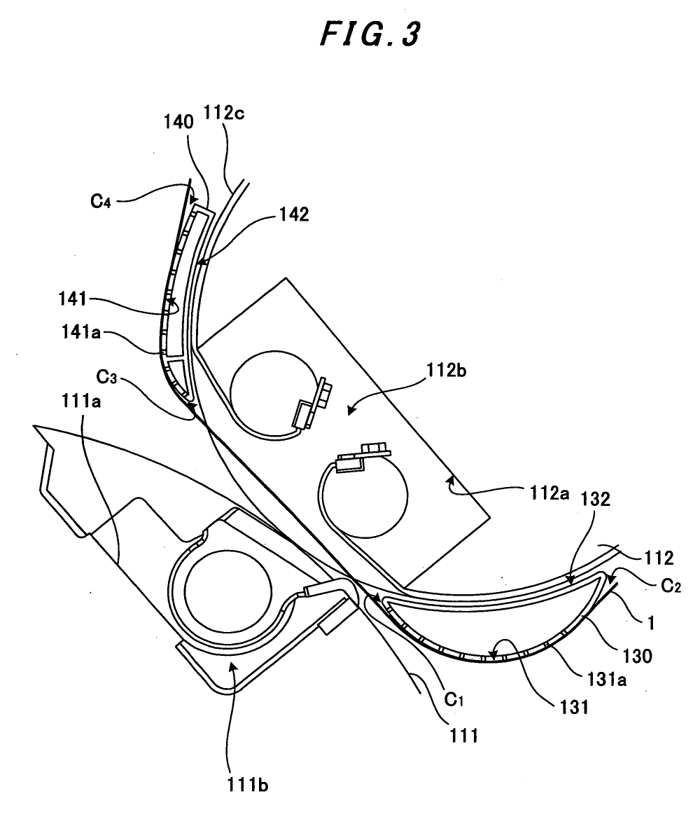

In a cross section taken along the radial direction of the press roller 112, the feeding guide 130 shows a shape of a crescent with its outer side in the radial direction swelling out and being arched. To be more specific, in the feeding guide 130, a middle portion in the traveling direction of the transfer foil 1 is formed to be thicker than the two end sides in the traveling direction thereof. Simply put, the feeding guide 130 is formed to be thinner as approaching the downstream side of the traveling direction of the transfer foil 1. The feeding guide 130 has a face 132 which is positioned on the inner side in a radial direction of the feeding guide 130 and which opposes the press roller 112. The face 132 is formed in an arc shape along the outer circumferential surface of the press roller 112. Meanwhile, the guide face 131 is formed also in an arc shape so that gaps C1 and C2 are created between the transfer foil 1 and the respective ends of the guide face 131 in the traveling direction of the transfer foil 1. When the notch portion 112a of the press roller 112 opposes the transport cylinder 111, the notch portion 112a of the press roller 112 opposes one of the notch portions 111a of the transport cylinder 111. In this event, the feeding guide 130 guides the traveling direction of the transfer foil 1 so that the transfer foil 1 can travel through the area of the notch portion 112a (see FIG. 3).

A discharging guide 140, serving as a downstream-side guide member, is disposed near a nip portion P between the transport cylinder 111 and the press roller 112, on the downstream side of the traveling direction of the transfer foil 1, at the press-roller 112 side. The transfer foil 1 coming through the nip between the transport cylinder 111 and the press roller 112 is then guided by the discharging guide 140. Once the transfer foil 1 leaves the nip portion P, the transfer foil thus guided travels closer to the press-roller 112 side than the side of a tangent line L that passes through the nip portion P.

The discharging guide 140 has a hollow structure and is connected to unillustrated air-supply means, specifically, an air pump. The discharging guide 140 has an arc-shaped guide face 141 which is positioned on the outer side in a radial direction of the press roller 112 and which guides the traveling direction of the transfer foil 1. A large number of ejection holes 141a are formed in the guide face 141 to eject air.

The discharging guide 140 is formed so that the thickness of the discharging guide 140 in the radial direction of the press roller 112 is made larger in the middle portion and on the downstream side in the traveling direction of the transfer foil 1 while the thickness on the upstream side in the traveling direction is made smaller. Simply put, the discharging guide 140 is formed to be thinner as approaching the upstream side of the traveling direction of the transfer foil 1. The discharging guide 140 has a face 142 which is positioned on the inner side in a radial direction of the discharging guide 140 and which opposes the press roller 112. The face 142 is formed in an arc shape along the outer circumferential surface of the press roller 112. Meanwhile, the guide face 141 is formed also in an arc shape so that gaps C3 and C4 are created between the transfer foil 1 and the respective ends of the guide face 141 in the traveling direction of the transfer foil 1. When the notch portion 112a of the press roller 112 opposes the transport cylinder 111, that is, when the notch portion 112a of the press roller 112 opposes one of the notch portions 111a of the transport cylinder 111, the discharging guide 140 guides the traveling direction of the transfer foil 1 so that the transfer foil 1 can travel through the area of the notch portion 112a (see FIG. 3).

A swing arm 115 is disposed near the press roller 112. The middle part of swing arm 115 is supported so that the swing arm 115 is capable of being driven to swing. Movable rollers 116 and 117 are disposed at the positions respectively near the ends of the swing arm 115.

A portion of the transfer foil 1 which has been fed from the feeder shaft 113 and is fed towards the nip between the press roller 112 and the transport cylinder 111 is wound around the movable roller 116 positioned on one side of the swing arm 115. Meanwhile, the other portion of the transfer foil 1 which has been fed from the nip between the press roller 112 and the transport cylinder 111 and is fed towards the collection shaft 114 is wound around the movable roller 117 on the other side of the swing arm 115.

A guide roller 118 is disposed near the movable roller 116 on the one side of the swing arm 115. The guide roller 118 guides the transfer foil 1 so that the portion of the transfer foil 1 which has been fed from the feeder shaft 113 can be wound onto the movable roller 116.

A guide roller 119 is disposed near the movable roller 117 on the other side of the swing arm 115. The guide roller 119 guides the transfer foil 1 so that the portion of the transfer foil 1 which has come from the nip between the press roller 112 and the transport cylinder 111 can be wound onto the movable roller 117.

To put it in other way, the swinging movement of the swing arm 115 moves positions of the movable rollers 116 and 117 simultaneously. The movement of the movable rollers 116 and 117 makes the traveling path of the transfer foil 1 on the feeder-shaft 113 side longer and the traveling path of the transfer foil 1 on the collection-shaft 114 side shorter, or, conversely, makes the traveling path of the transfer foil 1 on the feeder-shaft 113 side shorter and the traveling path of the transfer foil 1 on the collection-shaft 114 side longer.

In the drawings, reference numerals 120 to 126 represent guide rollers.

In this embodiment, the feeder shaft 113, the collection shaft 114, the guide rollers 118 to 126, and the like constitute transfer foil traveling means (transfer foil feeding means). The swing arm 115, the movable rollers 116 and 117, and the like constitute the foil-saving mechanism. Additionally, the above-mentioned “nip portion P” is the position where the transfer foil 1 is pressed on the paper sheet 2 so that foil of the transfer foil 1 is transferred onto the paper sheet 2. Accordingly, the “nip portion P” can also be called a “pressing portion P” or a “transfer portion P”.

Next, an operation of the foil transfer apparatus of this embodiment will be described.

While the cylinders 111, 128, and 129 are rotated, the paper sheet 2 with an adhesive agent that corresponds to the design having been transferred through the adhesive-agent transfer apparatus is transferred from the feeder apparatus to the transport cylinder 111 via the transfer cylinder 128. Meanwhile, the air pumps are operated so as to eject air through the ejection holes 131a and 141a formed respectively in the guides 130 and 140. In addition, the press roller 112 is rotated, and the transfer foil 1 is fed from the feeder shaft 113 so as to make the transfer foil 1 travel through the nip between the transport cylinder 111 and the press roller 112. Here, the roller 116, 118, 120, and 121, as well as the feeding guide 130 help the transfer foil 1 to travel in the above-mentioned way. Then, the paper sheet 2 supported on the outer circumferential surface of the transport cylinder 111 with the gripper devices 111b of the transport cylinder 111 opposes the pressing surface member 112c of the press roller 112. The transfer foil 1 is pressed onto the paper sheet 2. Thus, the foil of the transfer foil 1 is transferred onto the paper sheet 2 so that the foil to be transferred corresponds to the design formed with the adhesive agent and having been transferred in advance to the paper sheet 2. Once the foil is transferred to the paper sheet 2, the paper sheet is then discharged to the discharging apparatus via the transfer cylinder 129. The transfer foil 1 from which the foil has been transferred is then wound and collected by the collection shaft 114. Here, the discharging guide 140 as well as the rollers 117, 119, and 122 to 126 guides the traveling of the transfer foil 1. In this way, the foil which is continuously fed, and which has a shape corresponding to the design, is transferred onto the paper sheet 2.

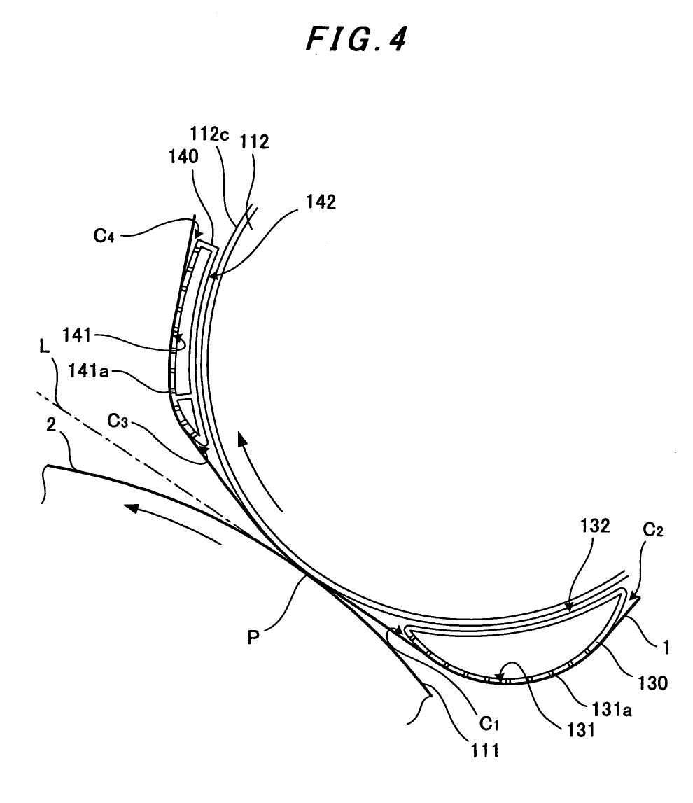

Here, while the pressing surface member 112c of the press roller 112 transfers the foil of the transfer foil 1 onto the paper sheet 2 supported on the outer circumferential surface of the transport cylinder 111, the discharging guide 140 guides the traveling of the portion of the transfer foil 1 coming from the nip between the transport cylinder 111 and the press roller 112 in a direction as shown in FIG. 4. Once the transfer foil 1 leaves the nip portion P, the transfer foil thus guided travels closer to the press-roller 112 side than the side of a tangent line L that passes through the nip portion P. Consequently, the transfer foil 1 can be separated from the paper sheet 2 easily with no base film of the transfer foil 1 being attached to the paper sheet 2 across the range from the nip portion P to the downstream side in the rotational direction of the transport cylinder 111, immediately after passing through the nip portion P.

Accordingly, disturbances in the tensile force of the transfer foil 1 are easily prevented from taking place near the nip between the press roller 112 and the transport cylinder 111. Consequently, the foil transferred onto the paper sheet 2 is easily prevented from having fine cracks or creases.

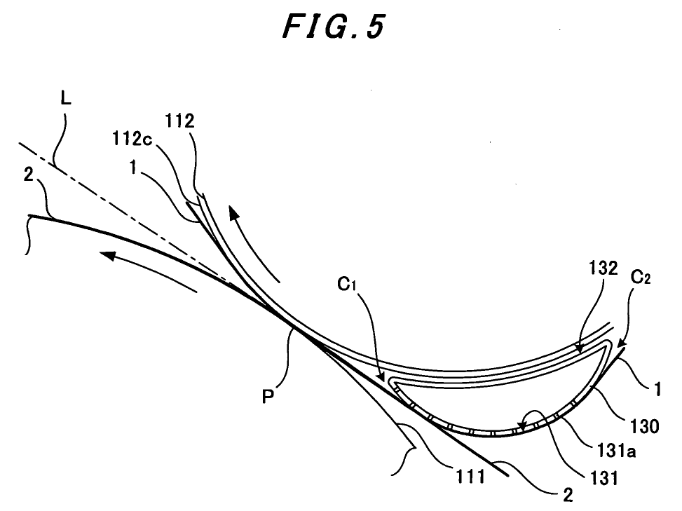

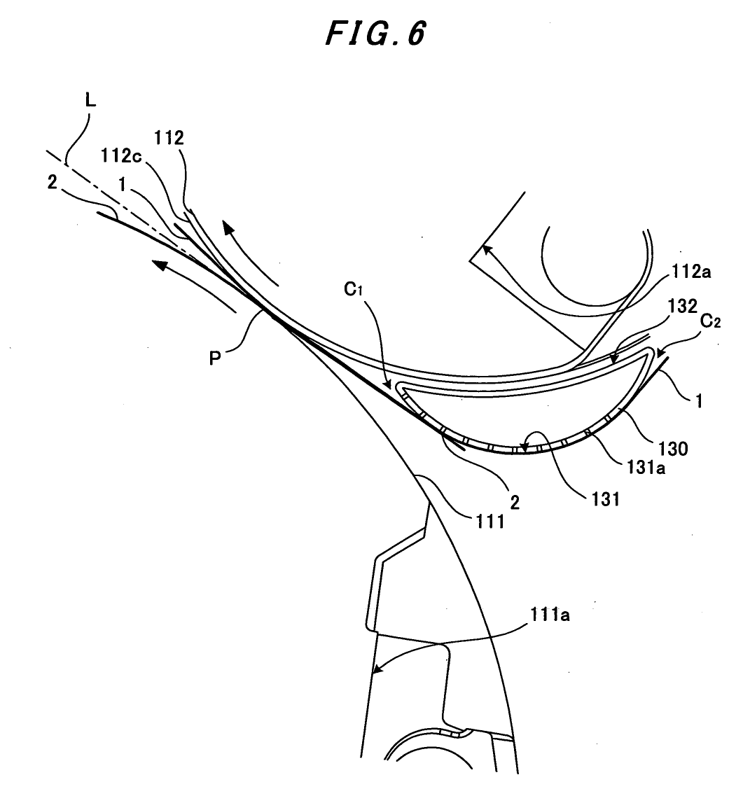

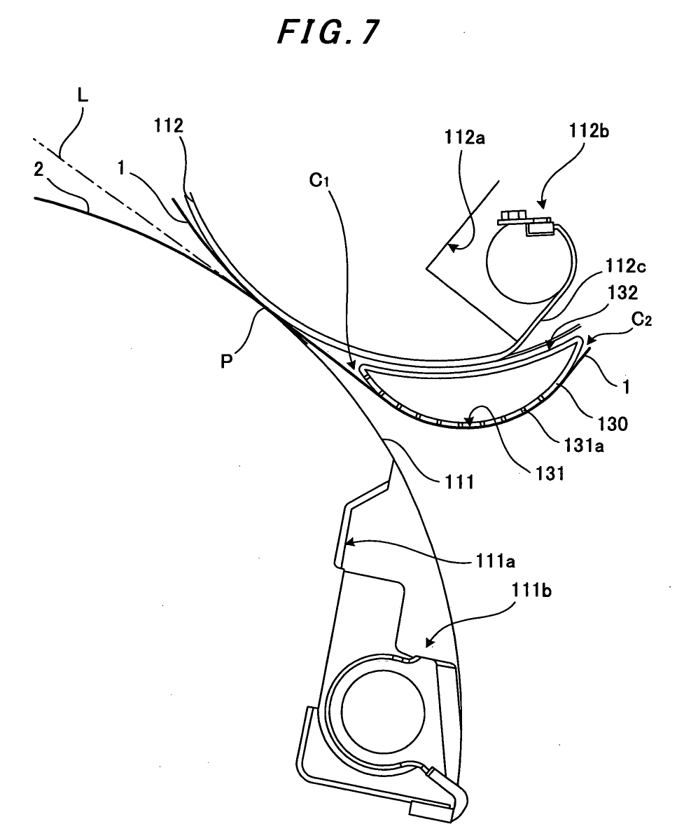

In the case of using a relatively thick paper sheet with its own relatively high stiffness, the rear-end side of the paper sheet 2 may not rest on the outer circumferential surface of the transport cylinder 111, but may bounce upwards, as shown in FIG. 5. Even in this case, as shown in FIGS. 6 and 7, the feeding guide 130 receives the impact given by the rear-end side of the bounced-up paper sheet 2 that collides with the transfer foil 1, and thus controls movement of the transfer foil 1 as well as the rear-end side of the paper sheet 2 in a direction orthogonal to the traveling direction of the transfer foil 1. Accordingly, the disturbances in the tensile force of the thin transfer foil 1 are prevented from being caused by the rear-end side of the paper sheet 2. Consequently, the transfer foil 1 is prevented from having creases, and is also prevented from traveling meanderingly.

In addition, assume that the transfer foil 1 and the paper sheet 2 travel always at the same speed. In this case, there is generated a large amount of the foil that is not transferred onto the paper sheet 2 and is wasted. This problem is addressed by the following operation. After the pressing surface member 112c of the press roller 112 attaches the foil of the transfer foil 1 onto the paper sheet 2 supported on the transport cylinder 111, the notch portion 112a of the press roller 112 and one of the notch portions 111a of the transport cylinder 111 oppose each other. At this time, the guides 130 and 140 guide the traveling direction of the transfer foil 1 so that the transfer foil 1 can travel through the area of the notch portion 112a of the press roller 112. In other words, the guided transfer foil 1 travels so as not to be in contact with the transport cylinder 111 and the press roller 112 (see FIG. 3).

In the meanwhile, by swinging the swing arm 115, the rollers 116 and 117 are moved so that the traveling path of the transfer foil 1 can be changed on the side of the rollers 116 and 118 as well as the side of the rollers 117 and 119.

Accordingly, when the pressing surface member 112c of the press roller 112 opposes a second foil-transfer position of the paper sheet 2 supported on the transporting roller 111, a portion of the transfer foil 1 near a first foil-transfer position to the paper sheet 2 is positioned at the nip between the press roller 112 and the transport cylinder 111. Accordingly, the distance between the part of the paper sheet 2 to which second foil of the transfer foil 1 is transferred and the part of the paper sheet 2 to which first foil of the transfer foil 1 has been transferred can be made extremely short. Thus, it can be achieved that a significant reduction in the waste of the portion of the foil of the transfer foil 1 that does not oppose the paper sheet 2 (foil-saving mechanism: for more detailed descriptions of the operation, see U.S. Pat. No. 6,334,248, and U.S. Pat. No. 6,491,780, for example).

Accordingly, even in the case of the transferring of the foil of the transfer foil 1 onto the relatively thick paper sheet 2, the use of the foil transfer apparatus according to this embodiment makes it possible to stabilize the tensile force of the transfer foil 1 with ease and to securely carry out foil saving.

In addition, the arc-shaped guide faces 131 and 141 of the respective guides 130 and 140 guide the traveling movement of the transfer foil 1 smoothly, and prevent the transfer foil 1 from having scratches when the transfer foil 1 including foil saving or the like is moved.

Moreover, air is ejected through the ejection holes 131a formed in the guide face 131 of the guide 130 and the ejection holes 141a formed in the guide face 141 of the guide 140. With this structure, the transfer foil 1 can be guided while slightly floating from the guide faces 131 and 141. In this way, the transfer foil 1 can be guided more smoothly and scratches on the transfer foil 1 can be prevented more securely.

Furthermore, each of the guide faces 131 and 141 of the respective guides 130 and 140 is formed with its two ends in the traveling direction of the transfer foil 1 being curved so as to create the gaps C1 to C4 between the transfer foil 1 and the guide faces 131 and 141. Accordingly, when the transfer foil 1 moves including the foil saving, the transfer foil 1 is prevented from getting caught with the two end portion in the traveling direction of each of the guide faces 131 and 141 of the respective guides 130 and 140. Consequently, the transfer foil 1 is prevented from having scratches with more certainty.

In addition, the guides 130 and 140 have the respective faces 132 and 142 which oppose the press roller 112 and each of which has an arc shape along the outer circumferential surface of the press roller 112. This shape allows the guides 130 and 140 to be disposed at positions that are as close as possible to the press roller 112, thereby eliminating waste of the traveling path. Such closeness prevents, with certainty, the disturbances in the tensile force of the transfer foil 1 from being caused by the rear-end side of the paper sheet 2. In addition, the transfer foil 1 is prevented from having creases and from traveling meanderingly with certainty. Moreover, since the face 132 of the feeding guide 130 has an arc shape as described above, the feeding guide 130 can be disposed at positions that are as close as possible to the press roller 112, thereby making it possible to securely receive the impact given by the rear-end side of the bounced-up paper sheet 2. Thus, the disturbances in the tensile force of the thin transfer foil 1 are more securely prevented from being caused, so that the transfer foil 1 can be more reliably prevented from having creases and can also be more reliably prevented from traveling meanderingly.

Additionally, each of the guides 130 and 140 is shaped so as to make its side of the nip portion P between the press roller 112 and the transport cylinder 111 thinner as approaching the nip portion P. Such a shape allows the guides 130 and 140 to be disposed at positions that are as close as possible to the nip portion P. In particular, when the feeding guide 130 is disposed at positions that are as close as possible to the nip portion P, the bounce of paper sheet 2 on its rear-end side can be securely received by the feeding guide 130. In this way, the disturbances in the tensile force of the thin transfer foil 1 are more securely prevented from being caused, and thus transfer foil 1 can be more reliably prevented from having creases and can also be prevented from traveling meanderingly.

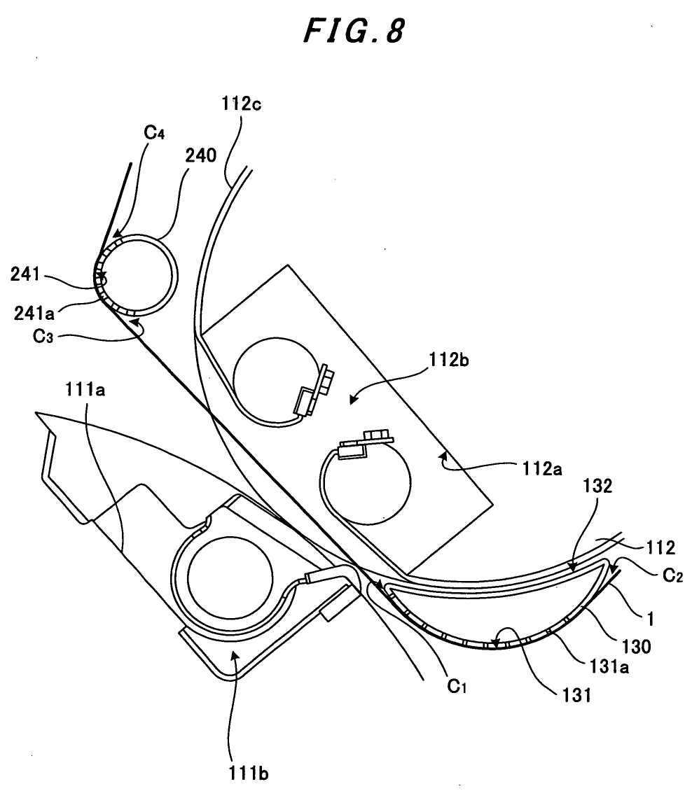

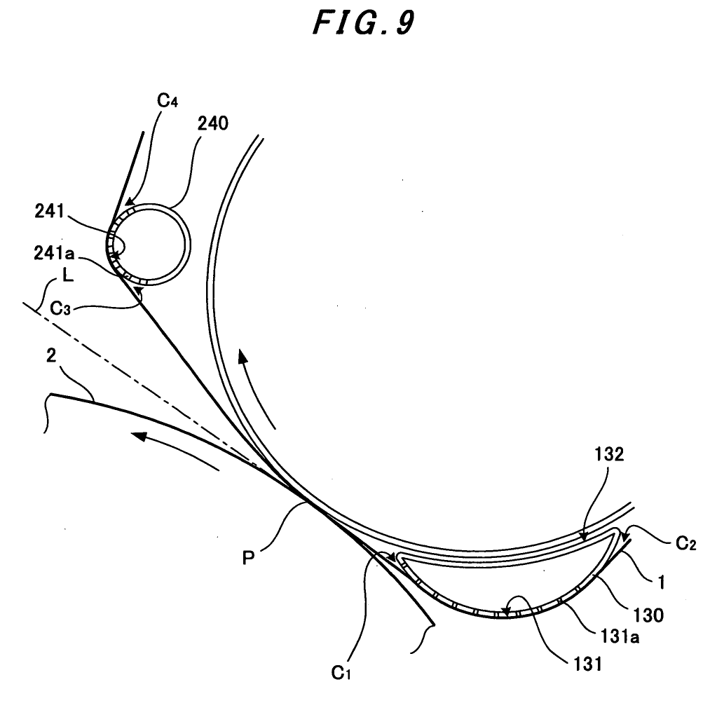

In this embodiment, the discharging guide 140 is formed so that the thickness of the discharging guide 140 in the radial direction of the press roller 112 is made smaller on the upstream side than in the middle portion and on the downstream side in the traveling direction of the transfer foil 1, while the face 142 which is positioned on the inner side in a radial direction of the discharging guide 140 and which opposes the press roller 112 is formed so as to have an arc shape along the outer circumferential surface of the press roller 112. As another embodiment, a discharging guide 240 such as one shown in FIGS. 8 and 9 can replace the discharging guide 140 and be disposed in the same manner as in the case of the discharging guide 140. To be more specific, the discharging guide 240 has a shape of a circular tube, and has a guide face 241 which is positioned at the outer side in the radial direction of the press roller 112 and which guides the movement of the transfer foil 1. In addition, a large number of ejection holes 241a through which air is ejected is formed in the guide face 241.

Nevertheless, the discharging guide 140 used in this embodiment is very preferable for the following reasons. As has been described above, the discharging guide 140 can be disposed at a position that is as close as possible to the press roller 112, and, at the same time, can be disposed at a position that is as close as possible to the nip portion P between the press roller 112 and the transport cylinder 111. Accordingly, on the downstream side of the traveling direction of the transfer foil 1 from the nip portion P of the transfer foil 1, the angle of the transfer foil 1 relative to the sheet paper 2 immediately after the nip portion P (This angle is also called a separation angle) can be obtained without contact with the press roller 112. As a result, the transfer foil 1 is securely separated from the sheet paper 2 immediately after foil is transferred from the transfer foil 1 to the sheet paper 2, thereby making it possible to prevent the transfer foil 1 from sticking to the sheet paper 2. In this way, the disturbances in the tensile force of the thin transfer foil 1 are more securely prevented from being caused by the rear-end side of the paper sheet 2, and thus transfer foil 1 can be more reliably prevented from having creases and can also be more reliably prevented from traveling meanderingly.

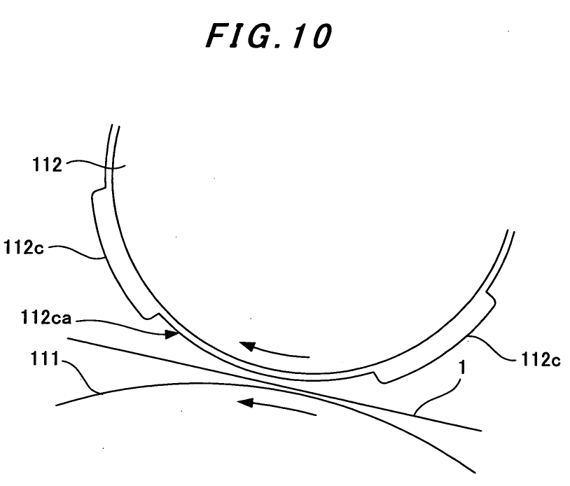

In addition, in this embodiment, after the pressing surface member 112c of the press roller 112 attaches the foil of the transfer foil 1 onto the paper sheet 2 supported on the transport cylinder 111, the notch portion 112a of the press roller 112 and one of the notch portions 111a of the transport cylinder 111 opposes each other. Meanwhile, the transfer foil 1 travels through the area of the notch portion 112a of the press roller 112. In other words, the transfer foil 1 is guided so as not to be in contact with the transport cylinder 111 and the press roller 112. While the transfer foil 1 is in the above-mentioned state, the transfer foil 1 is drawn back by a predetermined length from the side of the winding shaft 114 to the side of the feeder shaft 113, that is, the foil saving is carried out. FIG. 10, however, shows an example of other possible embodiments for the foil saving. To be more specific, firstly, a recessed notch portion 112ca is formed in the pressing surface member 112c of the press roller 112. While the notch portion 112ca formed in the pressing surface member 112c of the press roller 112 opposes the transport cylinder 111, the transfer foil 1 travels through the area of the notch portion 112ca formed in the pressing surface member 112c of the press roller 112. To put it in other way, the transfer foil is guided so as not to be in contact with the transporting roller 111 and the press roller 112. While the transfer foil is in the above-described state, the transfer foil 1 is drawn back by a predetermined length from the side of the winding shaft 114 to the side of the feeder shaft 113. In addition, when the notch portion 112ca is formed in the pressing surface member 112c as in the case that has just been described, the foil saving can be performed in the following way. The transfer foil 1 is drawn back from the side of the winding shaft 114 to the side of the feeder shaft 113 by a predetermined length both while the transfer foil travels through the area of the notch portion 112a of the press roller 112 and while the transfer foil 1 travels through the area of the notch portion 112ca formed in the pressing surface member 112c of the press roller 112.

In addition, in this embodiment, the present invention is applied to the cold foil transfer type foil transfer apparatus. In such a type foil transfer apparatus, the transfer foil 1 is pressed, by the press roller 112, onto the paper sheet 2 with adhesive agent having been transferred in advance so as to correspond to a design and thus the foil with a shape corresponding to the design is transferred onto the paper sheet 2. Another possible embodiment, however, is the application of the present invention to the hot foil stamping type foil transfer apparatus. In such a type foil transfer apparatus, the transfer foil having an adhesive layer is pressed onto a sheet by use of a press roller with the following configuration. The press roller has a pressing die having a design formed in a protruding manner. In addition, the pressing die is formed on the outer circumferential surface of the press roller and is capable of being heated. Thus, the foil of the transfer foil together with the help of the adhesive layer is transferred onto the sheet. The application of the present invention to the hot foil stamping type foil transfer apparatus can be done in the same manner as in the case of this embodiment.

In addition, descriptions of this embodiment are based on a case where the foil of the transfer foil 1 is transferred onto a sheet, that is, onto the paper sheet 2. This is not the only application of the present invention. The present invention can also be employed in cases where the foil of the transfer foil is transferred onto a planar transfer object with flexibility, such as a web.

The use of the foil transfer apparatus according to the present invention makes it possible to stabilize the tensile force of the transfer foil with ease and to carry out foil saving securely for the following reasons. The downstream-side guide member guides the transfer foil so that the transfer foil can travel closer to the press cylinder side than a tangent line passing through the nip portion between the supporting cylinder and the press cylinder. The transfer foil can thus be easily separated from the transfer object with no base film of the transfer foil being attached to the transfer object across the range from the nip portion to the downstream side in the rotational direction of the supporting cylinder.

Accordingly, the present invention is extremely useful in various industries.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A foil transfer apparatus, comprising:
a supporting cylinder that is rotatably supported and supports a transfer object on the outer circumferential surface of the supporting cylinder; and
a press cylinder that is rotatably supported and disposed so as to oppose the supporting cylinder,
the foil transfer apparatus causing the transfer object and a web-like transfer foil made by attaching foil on a base film to travel through the nip between the supporting cylinder and the press cylinder, and thereby transferring the foil of the transfer foil on the transfer object,
the foil transfer apparatus, further comprising:
a downstream-side guide member which is disposed at a position near a nip portion between the supporting cylinder and the press cylinder, on the downstream-side of the traveling direction of the transfer foil on the press cylinder side, and which guides the transfer foil, so that the transfer foil travels closer to the press cylinder side than a tangent line passing through the nip portion.

2. The foil transfer apparatus according to claim 1, wherein the downstream-side guide member is disposed at a position near the press cylinder.

3. The foil transfer apparatus according to claim 1, wherein the downstream-side guide member has an arc-shaped guide face that guides the transfer foil.

4. The foil transfer apparatus according to claim 1, wherein the downstream-side guide member has:
a guide face that guides the transfer foil; and
an ejection hole that is provided in the guide face to eject air supplied from air supply means.

5. The foil transfer apparatus according to claim 1, wherein the downstream-side guide member has a guide face that guides the transfer foil with an end portion located on the upstream side in the traveling direction of the transfer foil, the end portion being curved and thereby a gap being created between the end portion and the transfer foil.

6. The foil transfer apparatus according to claim 2, wherein the downstream-side guide member has a face which opposes the press cylinder and which has an arc shape along the outer circumferential surface of the press cylinder.

7. The foil transfer apparatus according to claim 6, wherein the downstream-side guide member is formed to have a thickness in a radial direction of the press cylinder on the upstream side in the traveling direction of the transfer foil, the thickness becoming thinner as the guide member approaches the upstream side in the traveling direction.

8. The foil transfer apparatus according to claim 1, wherein
the press cylinder has a notch portion on the outer circumferential surface thereof, and
the downstream-side guide member guides the transfer foil so that when the notch portion of the press cylinder opposes the supporting cylinder, the transfer foil travels through the area of the notch portion of the press cylinder.
